(19) United States
(12) Patent Application Publication
(10) Pub. No.: US 2018/0367234 A1
(43) Pub. Date: Dec. 20, 2018

(54) ROUTE AND COLLECT RECONFIGURABLE OPTICAL ADD/DROP MULTIPLEXER

(71) Applicant: FUJITSU LIMITED, Kawasaki-Shi Kanagawa (JP)

(72) Inventor: Eric Koopferstock, Plano, TX (US)

(73) Assignee: FUJITSU LIMITED, Kawasaki-Shi Kanagawa (JP)

(21) Appl. No.: 15/624,395

(22) Filed: Jun. 15, 2017

(51) Int. Cl. H04J 14/02

(52) U.S. Cl. CPC H04J 14/0212

(57) ABSTRACT

Methods and systems for implementing a route and collect ROADM include a route stage incorporating a 1×2 wavelength selective element to split pass through wavelengths and dropped wavelengths from and input WDM signal. Additional optical functionality of the route and collect ROADM may be implemented using passive optical elements, such as a collect stage comprising an optical coupler to combine add wavelengths with the pass through wavelengths.

BACKGROUND

### Field of the Disclosure

The present disclosure relates generally to optical communication networks and, more particularly, to a route and collect reconfigurable optical add/drop multiplexer (ROADM).

### Description of the Related Art

Telecommunication, cable television and data communication systems use optical networks to rapidly convey large amounts of information between remote points. In an optical network, information is conveyed in the form of optical signals through optical fibers. Optical fibers may comprise thin strands of glass capable of communicating the signals over long distances. Optical networks often employ modulation schemes to convey information in the optical signals over the optical fibers. Such modulation schemes may include phase-shift keying (PSK), frequency-shift keying (FSK), amplitude-shift keying (ASK), and quadrature amplitude modulation (QAM).

Optical networks may also include various optical elements, such as amplifiers, dispersion compensators, multiplexer/demultiplexer filters, wavelength selective switches (WSS), optical switches, splitters, couplers, etc. to perform various operations within the network. In particular, optical networks may include reconfigurable optical add-drop multiplexers (ROADMs) that enable routing of optical signals and individual wavelengths to different destinations.

### SUMMARY

In one aspect, a reconfigurable optical add/drop multiplexer (ROADM) is disclosed. The ROADM may include a route stage enabled to receive an input degree and enabled to output a first output degree and a second output degree. In the ROADM, the route stage may include a wavelength selective element to route wavelengths in the input degree to at least one of the first output degree and the second output degree. The ROADM may further include a collect stage enabled to receive the first output degree from the route stage and a second input degree and enabled to output a third output degree. In the ROADM, the collect stage may include an optical coupler that combines the first output degree and the second input degree to generate the third output degree.

In any of the disclosed embodiments of the ROADM, the wavelength selective element may further include a 1×2 wavelength selective switch (WSS).

In any of the disclosed embodiments of the ROADM, the wavelength selective element may further include an optical splitter receiving the input degree and having a first output and second output, a first waveblocker array receiving the first output and outputting the first output degree, and a second waveblocker array receiving the second output and outputting the second output degree. In the ROADM, the first waveblocker array and the second waveblocker array may respectively be enabled to block individual wavelengths received as input.

In any of the disclosed embodiments of the ROADM, the second output degree may be a drop port for wavelengths in the input degree, while the wavelength selective element may route each wavelength in the input degree to one of the first output degree and the second output degree.

In any of the disclosed embodiments of the ROADM, the route stage may further include an optical drop splitter to split the second output degree into a plurality of degrees.

In any of the disclosed embodiments of the ROADM, the route stage may further include an arrayed waveguide grating to split wavelengths in the second output degree into individual wavelength channels.

In any of the disclosed embodiments of the ROADM, the collect stage may further include an optical add coupler to combine add degrees for the second input degree.

In any of the disclosed embodiments of the ROADM, the add degrees may be individual wavelengths for the second input degree, while the collect stage may further include a plurality of variable optical attenuators (VOA) corresponding to the individual wavelengths and enabled to respectively attenuate each of the individual wavelengths.

In any of the disclosed embodiments of the ROADM, the collect stage may further include a third waveblocker array enabled to block wavelengths from the optical add coupler.

In any of the disclosed embodiments of the ROADM, the collect stage may further include an arrayed waveguide grating to combine wavelengths for the second input degree.

In any of the disclosed embodiments of the ROADM, the route stage may further include a first multicast switch enabled to receive the second output degree and another output degree from another route stage, while the collect stage may further include a second multicast switch enabled to output the second input degree and another input degree to another collect stage.

Additional disclosed aspects include an optical network including the route and collect ROADM, as disclosed herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an optical network;

FIGS. 2A, 2B, 2C, 2D, 2E, 2F, and 2G are block diagrams of selected elements of different implementations of a route and collect ROADM; and

FIG. 3 is a block diagram of selected elements of an embodiment of a route and collect ROADM.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted above, ROADMs are deployed in many applications in optical networks. Typical ROADMs are designed to accommodate 8 or more degrees, each of which may support up to 96 optical channels or wavelengths in particular implementations. In describing a ROADM generally, a ‘degree’ is a term used to describe a switched optical path to or from the ROADM, which may be a bidirectional optical path or a pair of optical fibers in some instances. However, it has been observed that a typical ROADM in use utilizes two degrees and a small number of add and drop wavelengths.

Typical designs for ROADMs include a so-called “route and select” architecture in which two wavelength selective switches (WSS) are used to select and route optical signals. However, a WSS is a relatively complex optical device and typical designs for route and select ROADMs accommodate 8 or more degrees. Concurrently, the use of coherent receiver optics has become widespread and provides the ability to exclusively tune a desired wavelength.

As will be described in further detail, a route and collect ROADM is disclosed herein that is enabled to support the bandwidth of an optical signal. The route and collect ROADM disclosed herein may be implemented with a single 1×2 wavelength selective element, such as a WSS among other implementations, along with other passive optical elements. The route and collect ROADM disclosed herein may be implemented as a bidirectional device that can support optical signals traveling in both directions along an optical network. The route and collect ROADM disclosed herein may support add and drop of a plurality of wavelengths while transmitting a pass through optical signal with full bandwidth.

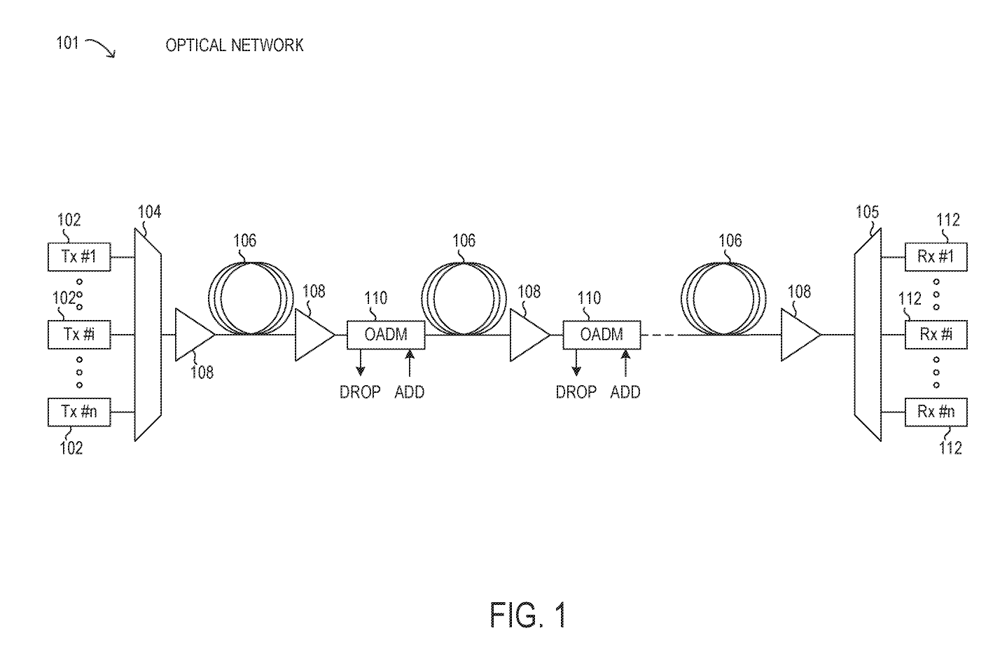

Referring now to the drawings, FIG. 1 illustrates an example embodiment of optical network 101, which may represent an optical communication system. Optical network 101 may include one or more optical fibers 106 to transport one or more optical signals communicated by components of optical network 101. The network elements of optical network 101, coupled together by fibers 106, may comprise one or more transmitters 102, one or more multiplexers (MUX) 104, one or more optical amplifiers 108, one or more optical add/drop multiplexers (OADM) 110, one or more demultiplexers (DEMUX) 105, and one or more receivers 112.

Optical network 101 may comprise a point-to-point optical network with terminal nodes, a ring optical network, a mesh optical network, or any other suitable optical network or combination of optical networks. Optical network 101 may be used in a short-haul metropolitan network, a long-haul inter-city network, or any other suitable network or combination of networks. The capacity of optical network 101 may include, for example, 100 Gbit/s, 400 Gbit/s, or 1 Tbit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a Single-Mode Fiber (SMF), Enhanced Large Effective Area Fiber (E-LEAF), or TrueWave® Reduced Slope (TW-RS) fiber.

Optical network 101 may include devices to transmit optical signals over optical fibers 106. Information may be transmitted and received through optical network 101 by modulation of one or more wavelengths of light to encode the information on the wavelength. In optical networking, a wavelength of light may also be referred to as a channel that is included in an optical signal (also referred to herein as a “wavelength channel”). Each channel may carry a certain amount of information through optical network 101.

To increase the information capacity and transport capabilities of optical network 101, multiple signals transmitted at multiple channels may be combined into a single wideband optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit-rate of solely one wavelength. With more bandwidth, optical networks are capable of transmitting greater amounts of information. Optical network 101 may transmit disparate channels using WDM or some other suitable multi-channel multiplexing technique, and to amplify the multi-channel signal.

Optical network 101 may include one or more optical transmitters (Tx) 102 to transmit optical signals through optical network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information contained in the electrical signals onto a beam of light produced by the laser at a particular wavelength, and transmit the beam for carrying the signal throughout optical network 101.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical network 101. Optical amplifiers 108 may be positioned before or after certain lengths of fiber 106. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of an optical pump to excite the atoms of the doped portion of the optical fiber, which increases the intensity of the optical signal. As an example, optical amplifiers 108 may comprise an erbium-doped fiber amplifier (EDFA).

OADMs 110 may be coupled to optical network 101 via fibers 106. OADMs 110 comprise an add/drop module, which may include a system, apparatus or device to add and drop optical signals (for example at individual wavelengths) from fibers 106. After passing through an OADM 110, an optical signal may travel along fibers 106 directly to a destination, or the signal may be passed through one or more additional OADMs 110 and optical amplifiers 108 before reaching a destination.

In certain embodiments of optical network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) that may be included in a ROADM. ROADMs are considered ‘colorless’ when the ROADM is able to add/drop any arbitrary wavelength. ROADMs are considered ‘directionless’ when the ROADM is able to add/drop any wavelength regardless of the direction of propagation. ROADMs are considered contentionless' when the ROADM is able to switch any contended wavelength (already occupied wavelength) to any other wavelength that is available. As shown OADM 110 may represent an implementation of a route and collect ROADM, as disclosed herein.

As shown in FIG. 1, optical network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical network 101 may transmit and carry a forty (40) channel DWDM signal. Demultiplexer 105 may divide the single, forty channel DWDM signal into forty separate signals according to the forty different channels.

In FIG. 1, optical network 101 may also include receivers 112 coupled to demultiplexer 105. Each receiver 112 may receive optical signals transmitted at a particular wavelength or channel, and may process the optical signals to obtain (e.g., demodulate) the information (i.e., data) that the optical signals contain. Accordingly, network 101 may include at least one receiver 112 for every channel of the network.

Optical networks, such as optical network 101 in FIG. 1, may employ modulation techniques to convey information in the optical signals over the optical fibers. Such modulation schemes may include phase-shift keying (PSK), frequency-shift keying (FSK), amplitude-shift keying (ASK), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

Additionally, polarization division multiplexing (PDM) technology may enable achieving a greater bit rate for information transmission. PDM transmission comprises independently modulating information onto different polarization components of an optical signal associated with a channel. In this manner, each polarization component may carry a separate signal simultaneously with other polarization components, thereby enabling the bit rate to be increased according to the number of individual polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In an optical network, such as optical network 101 in FIG. 1, it is typical to refer to a management plane, a control plane, and a transport plane (sometimes called the physical layer). A central management host (not shown) may reside in the management plane and may configure and supervise the components of the control plane. The management plane includes ultimate control over all transport plane and control plane entities (e.g., network elements). As an example, the management plane may consist of a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, and an operational support system (OSS) which handles network-wide operations.

Modifications, additions or omissions may be made to optical network 101 without departing from the scope of the disclosure. For example, optical network 101 may include more or fewer elements than those depicted in FIG. 1. Also, as mentioned above, although depicted as a point-to-point network, optical network 101 may comprise any suitable network topology for transmitting optical signals such as a ring, a mesh, and a hierarchical network topology.

As discussed above, the amount of information that may be transmitted over an optical network may vary with the number of optical channels coded with information and multiplexed into one signal. Accordingly, an optical fiber employing a WDM signal may carry more information than an optical fiber that carries information over a single channel. Furthermore, ROADMs are used to route individual channels (wavelengths) at nodes in optical network 101. For example, a ROADM node enables adding or dropping of individual wavelengths to a WDM signal. In this manner, different networks and destination nodes may be reached with a given network topology, by routing individual wavelengths using ROADMs.

As will be described in further detail below, the ROADMs in optical network 101 may be a route and collect ROADM having a single 1×2 wavelength selective element along with other passive optical elements, such as optical splitters and optical couplers. For example, the optical couplers and optical splitters disclosed herein may be fused biconical taper (FBT) designs in which multiple fibers are fused together to passively split or combine an optical signal. In some implementations, the optical couplers and optical splitters disclosed herein may be planar lightwave circuit (PLC) designs, in which light paths are created using lithography on a substrate, which enables precise miniaturization. The passive optical splitters and optical couplers do not regulate optical power and result in a corresponding division of optical power (optical splitter) or multiplication of optical power (optical coupler) at the respective outputs.

Additionally, certain active optical elements may be used in the route and collect ROADM disclosed herein. For example, in some implementations, the 1×2 wavelength selective element may be a 1×2 WSS. In some implementations, the 1×2 wavelength selective element may include waveblocker arrays that are programmable to block one or more desired input wavelengths, while passing the remaining wavelengths without attenuation of optical power for each individual wavelength. In some implementations, variable optical attenuators (VOA) may be used to attenuate optical power for a single wavelength that is added by the route and collect ROADM disclosed herein. In still other implementations, an arrayed waveguide grating (AWG) may be used as a wavelength multiplexer or demultiplexer, for example for add or drop wavelengths for the route and collect ROADM disclosed herein.

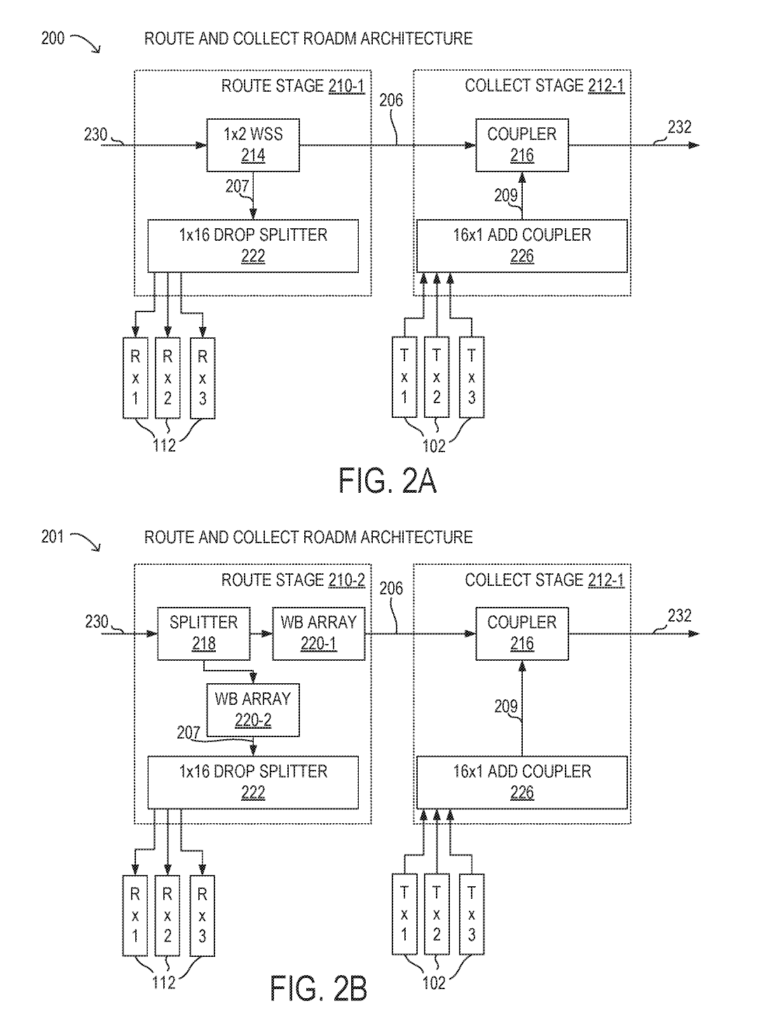

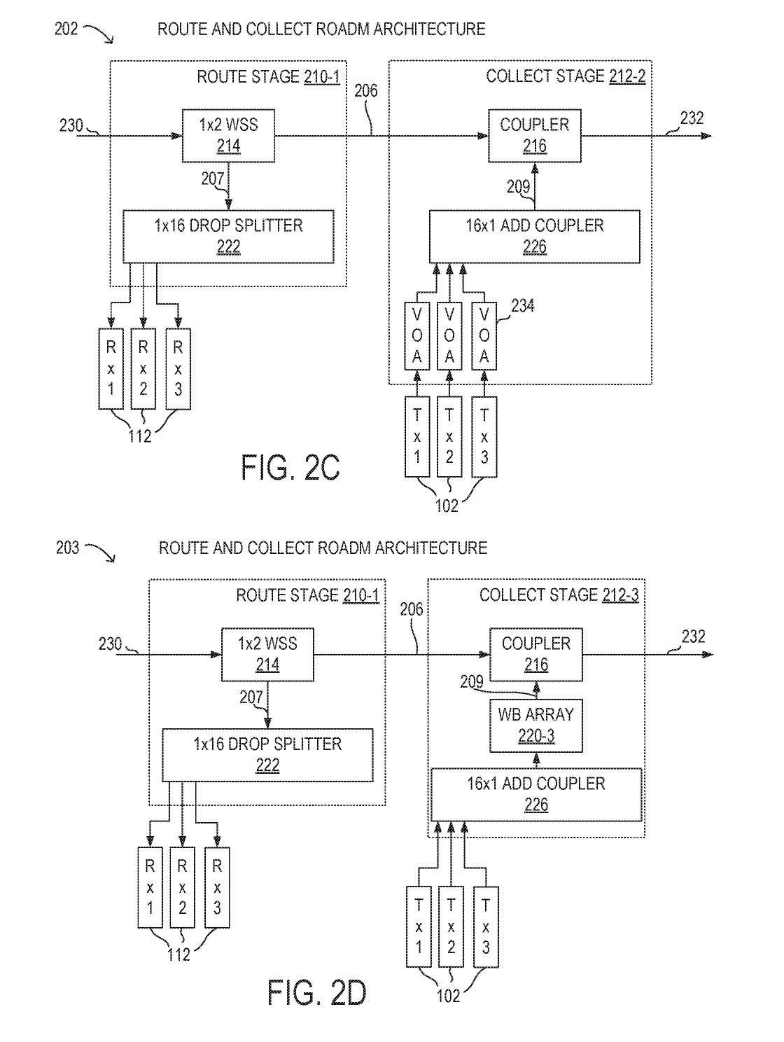

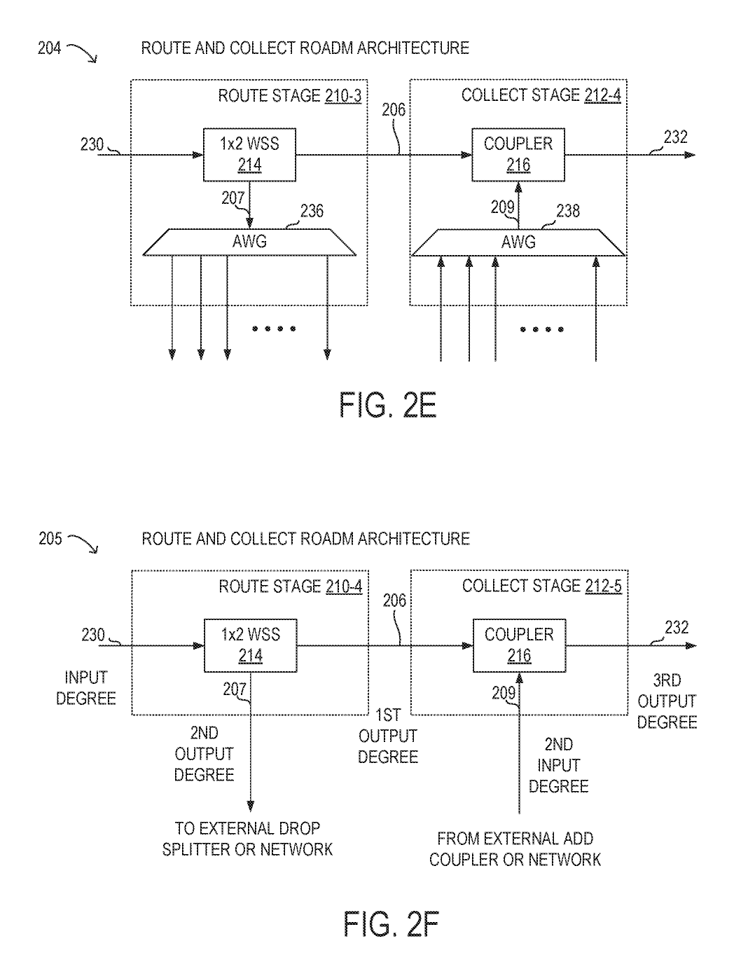

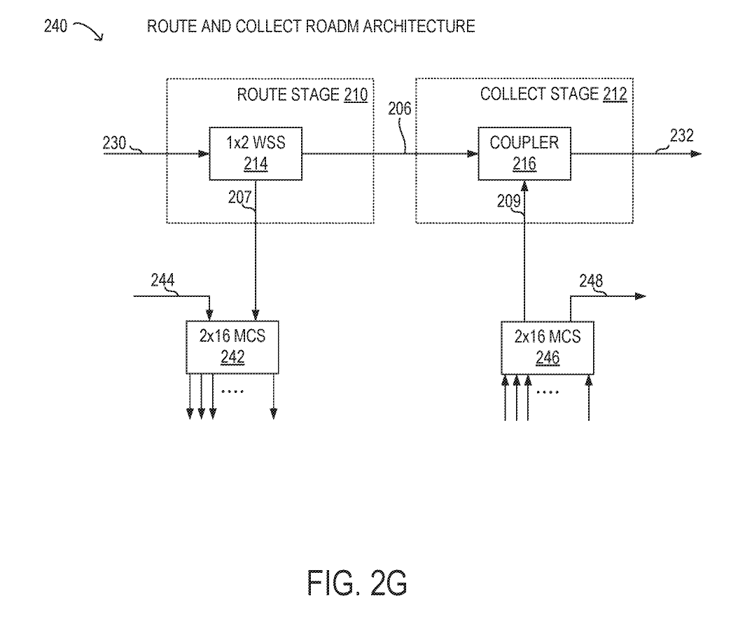

FIGS. 2A, 2B, 2C, 2D, 2E, and 2F show various implementations of route and collect ROADM architectures. It will be understood that in any given implementation or embodiment, any of the features described herein for a route and collect ROADM architecture may be combined or used in different implementations or embodiments. It is further noted that various optical components, such as optical amplifiers, filters, and other types of compensators, among other devices, may be used in the route and collect ROADM architectures disclosed herein.

Referring now to FIG. 2A, selected elements of an example embodiment of a route and collect ROADM architecture 200 is shown. As shown, architecture 200 is a schematic illustration and is not drawn to scale. It will be understood that, in different embodiments, ROADM architecture 200 may be implemented with fewer or more components than illustrated in FIG. 2A. In particular, it will be understood that ROADM architecture 200 may be dimensioned with fewer or more degrees for use in optical networks of different sizes, topographies, and complexity, such as optical network 101. It will be understood that additional input and output degrees may be used to extend the capacity of ROADM architecture 200. As shown in architecture 200, a route and collect ROADM may include a route stage 210-1 and a collect stage 212-1.

Route stage 210 may receive input degree 230, which may carry a WDM signal comprised of one or more individual wavelengths. In some embodiments, input degree 230 may carry up to 96 wavelengths or more. Route stage 210 may further include a 1×2 wavelength selective element.

In architecture 200, the 1×2 wavelength selective element in route stage 210-1 is a 1×2 WSS 214 (or simply WSS 214) having one input degree 230 and two output degrees (206, 207). From WSS 214, a first output degree 206 carries pass through wavelengths that are transmitted, via collect stage 212, through to a third output degree 232. Also from WSS 214, a second output degree 207 carries drop wavelengths to 133 6 drop splitter 222, which is a passive optical splitter enabled to replicate second output degree 207 over 16 outputs, with a corresponding ˜16:1 reduction in optical power. It will be understood that 1×16 drop splitter 222 is shown in an exemplary implementation, and other dimensions than 1×16, such as 1×2, 1×4, 1×6, 1×8, among others, may be used in different implementations. At drop splitter 222, each output carries all the wavelengths that are routed from WSS to second output degree 207. Each output from drop splitter 222 may be fed to a receiver 112 that is a coherent optical receiver that can tune to a single wavelength to demodulate and receive the data being carried over the single wavelength. Receivers 112 may be tuned according to drop functionality of WSS 214 that determines the wavelengths in second output degree 207. Although only 3 receivers 112 are shown for descriptive clarity, it will be understood that each output from drop splitter 222 may be received coherently by a respective receiver 112.

Then, first output degree 206 is coupled to collect stage 212, where wavelengths may be added. In collect stage 212-1, a coupler 216 receives first output degree 206 and a second input degree 209 from a 16x1 add coupler 226 with a corresponding increase in optical power based on the optical power of the inputs to add coupler 226. It will be understood that 16×1 add coupler 226 is shown in an exemplary implementation, and other dimensions than 16×1, such as 2×1, 4×1, 6×1, 8×1, among others, may be used in different implementations. The inputs to add coupler 226 in architecture 200 arrive from a transmitter 102 at each respective input. Because transmitter 102 is tuned to or used with a laser source having a given wavelength, second input degree 209 will carry all added wavelengths from add coupler 226. Although only 3 transmitters 102 are shown for descriptive clarity, it will be understood that each input to add coupler 226 may receive a wavelength from a respective transmitter 102. From coupler 216 in collect stage 212-1, third output degree 232 is transmitted further along the optical network.

Referring now to FIG. 2B, selected elements of an example embodiment of a route and collect ROADM architecture 201 is shown. As shown, architecture 201 is a schematic illustration and is not drawn to scale. It will be understood that, in different embodiments, ROADM architecture 201 may be implemented with fewer or more components than illustrated in FIG. 2B. In particular, it will be understood that ROADM architecture 201 may be dimensioned with fewer or more degrees for use in optical networks of different sizes, topographies, and complexity, such as optical network 101. It will be understood that additional input and output degrees may be used to extend the capacity of ROADM architecture 201. As shown in architecture 201, a route and collect ROADM may include a route stage 210-2 and a collect stage 212-1. Collect stage 212-1 in architecture 201 of FIG. 2B is the same as described above for architecture 200 in FIG. 2A.

In architecture 201, the 1×2 wavelength selective element in route stage 210-1 is implemented using waveblocker (WB) arrays 220 instead of WSS 214. Specifically, input degree 230 is passively split by optical splitter 218, such that about half of the optical power in input degree 230 is carried to WB array 220-1 and about half of the optical power is carried to WB array 220-2. It is noted that various different kinds of optical splitters may be used, for example, with equivalent or non-equivalent division of the input optical power at the outputs of the optical splitter. WB array 220-1 may be controlled to block all wavelengths other than pass through wavelengths in first output degree 206, which is output by WB array 220-1. WB array 220-2 may be controlled to block all wavelengths other than wavelengths in second output degree 207. Typically, first output degree 206 and second output degree 207 will not share any common wavelengths. However, the operation of WB arrays 220 may permit transmission of common wavelengths in some implementations and instances. Also shown in architecture 201 is drop splitter 222, which operates as described previously with respect to FIG. 2A.

Referring now to FIG. 2C, selected elements of an example embodiment of a route and collect ROADM architecture 202 is shown. As shown, architecture 202 is a schematic illustration and is not drawn to scale. It will be understood that, in different embodiments, ROADM architecture 202 may be implemented with fewer or more components than illustrated in FIG. 2C. In particular, it will be understood that ROADM architecture 202 may be dimensioned with fewer or more degrees for use in optical networks of different sizes, topographies, and complexity, such as optical network 101. It will be understood that additional input and output degrees may be used to extend the capacity of ROADM architecture 202. As shown in architecture 202, a route and collect ROADM may include a route stage 210-1 and a collect stage 212-2. Route stage 210-1 in architecture 202 of FIG. 2C is the same as described above for architecture 200 in FIG. 2A.

In architecture 202, collect stage 212-2 is shown including a VOA 234 for each input to add coupler 226. Although, 3 VOAs 234 and corresponding transmitters 102 are shown in FIG. 2C for descriptive clarity, it will be understood that each input to add coupler 226 may be equipped with a respective VOA 234 and may receive a wavelength from a respective transmitter 102. VOAs 234 may be used to attenuate the optical power of individual inputs to add coupler 226. In this manner, power equalization and control may be realized at collect stage 212-2. In some implementations, VOA 234 may be used as a safety feature to limit or block undesired wavelengths. For example, when two identical wavelengths are mistakenly routed to add coupler 226, VOA 234 may be used to block one of the duplicate wavelengths. Additionally, in architecture 202, VOA 234 may be used to modulate the optical power of the wavelength received from transmitter 102. For example, VOA 234 may be used to equalize the optical power among all inputs to collect stage 212-2, which may be beneficial or desirable.

Referring now to FIG. 2D, selected elements of an example embodiment of a route and collect ROADM architecture 203 is shown. As shown, architecture 203 is a schematic illustration and is not drawn to scale. It will be understood that, in different embodiments, ROADM architecture 203 may be implemented with fewer or more components than illustrated in FIG. 2D. In particular, it will be understood that ROADM architecture 203 may be dimensioned with fewer or more degrees for use in optical networks of different sizes, topographies, and complexity, such as optical network 101. It will be understood that additional input and output degrees may be used to extend the capacity of ROADM architecture 203. As shown in architecture 203, a route and collect ROADM may include a route stage 210-1 and a collect stage 212-3. Route stage 210-1 in architecture 203 of FIG. 2D is the same as described above for architecture 200 in FIG. 2A.

In architecture 203, collect stage 212-2 is shown including a WB array 220-3 at the output from add coupler 226. WB array 220-3 may represent a safety feature to block undesired wavelengths that may be mistakenly connected to add coupler 226.

Referring now to FIG. 2E, selected elements of an example embodiment of a route and collect ROADM architecture 204 is shown. As shown, architecture 204 is a schematic illustration and is not drawn to scale. It will be understood that, in different embodiments, ROADM architecture 204 may be implemented with fewer or more components than illustrated in FIG. 2E. In particular, it will be understood that ROADM architecture 204 may be dimensioned with fewer or more degrees for use in optical networks of different sizes, topographies, and complexity, such as optical network 101. It will be understood that additional input and output degrees may be used to extend the capacity of ROADM architecture 204. As shown in architecture 204, a route and collect ROADM may include a route stage 210-3 and a collect stage 212-4.

In architecture 204, route stage 210-3 and collect stage 212-4 are implemented using a demultiplexer 236 to split dropped wavelengths from second output degree 207 and a multiplexer 238 to combine added wavelengths at second input degree 209. Demultiplexer 236 and multiplexer 238 may be arrayed waveguide gratings that optically split/combine individual wavelengths. In this manner, the optical power of a given wavelength may be maintained or preserved. As noted above, demultiplexer 236 may output each wavelength to a receiver, while multiplexer 238 may receive a wavelength from a transmitter at each input.

Referring now to FIG. 2F, selected elements of an example embodiment of a route and collect ROADM architecture 205 is shown. As shown, architecture 205 is a schematic illustration and is not drawn to scale. It will be understood that, in different embodiments, ROADM architecture 205 may be implemented with fewer or more components than illustrated in FIG. 2F. In particular, it will be understood that ROADM architecture 205 may be dimensioned with fewer or more degrees for use in optical networks of different sizes, topographies, and complexity, such as optical network 101. It will be understood that additional input and output degrees may be used to extend the capacity of ROADM architecture 205. As shown in architecture 205, a route and collect ROADM may include a route stage 210-4 and a collect stage 212-5.

In architecture 205, a core implementation of a route and collect ROADM is shown. At route stage 210-4, second output degree 207 may be connected to an external drop splitter or may directly be carried to another optical network (not shown). At collect stage 212-5, second input degree 209 may be connected to an external add coupler or may directly receive an optical signal from yet another optical network (not shown). It is noted that in some implementations, architecture 205 may be used with an external device, such as an external splitter/coupler unit that is correspondingly dimensioned to support architecture 205.

Referring now to FIG. 2G, selected elements of an example embodiment of a route and collect ROADM architecture 240 is shown. As shown, architecture 240 is a schematic illustration and is not drawn to scale. It will be understood that, in different embodiments, ROADM architecture 240 may be implemented with fewer or more components than illustrated in FIG. 2G. In particular, it will be understood that ROADM architecture 240 may be dimensioned with fewer or more degrees for use in optical networks of different sizes, topographies, and complexity, such as optical network 101. It will be understood that additional input and output degrees may be used to extend the capacity of ROADM architecture 240. As shown in architecture 240, a route and collect ROADM may include a route stage 210 and a collect stage 212, as described previously.

In architecture 240, second output degree 207 is routed to a 2×16 multicast switch (MCS) 242, which may also accept another output degree from another route stage as input degree 244. Then, 2×16 MCS 242 may output up to 16 different ports, each of which may be either second output degree 207 or input degree 244, for demodulation by a coherent receiver. At collect stage 212, 2×16 MCS 246 may receive up to 16 added wavelengths that can be combined into second input degree 209 or input degree 248 which is routed to another collect stage. In this manner, 2×16 MCS 242 may enable colorless, directionless, and contentionless adding and dropping of individual wavelengths. It will be understood that various other dimensions and sizes of multicast switches may be used in different implementations.

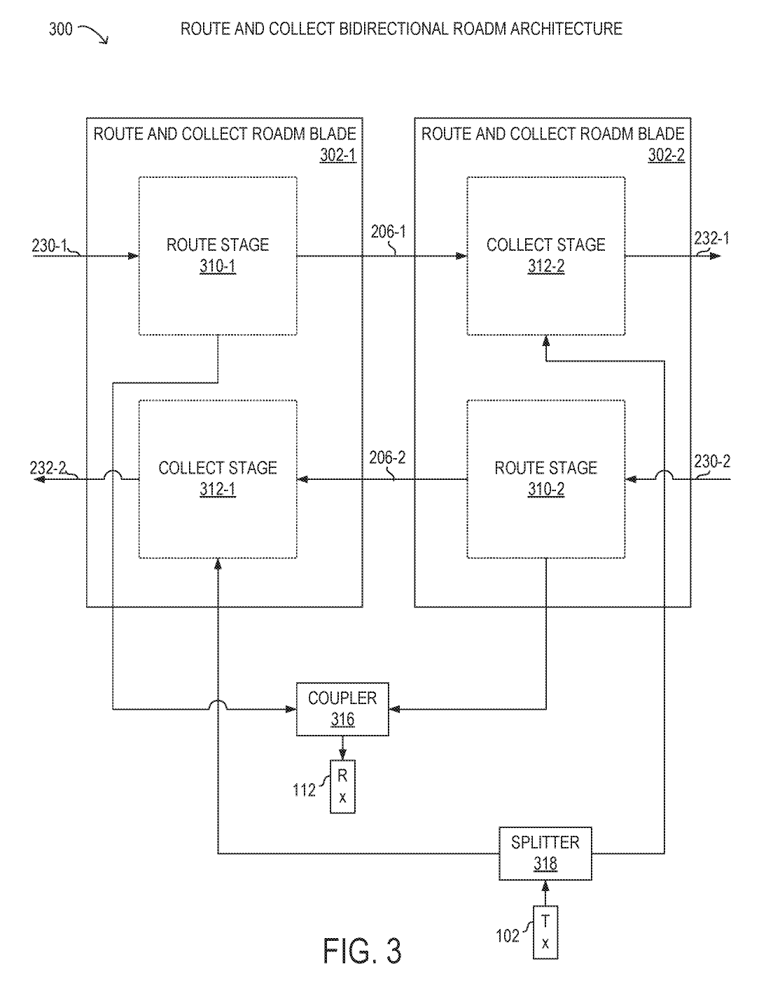

Referring now to FIG. 3, selected elements of an example embodiment of a route and collect bidirectional ROADM architecture 300 is shown. As shown, architecture 300 is a schematic illustration and is not drawn to scale. It will be understood that, in different embodiments, ROADM architecture 300 may be implemented with fewer or more components than illustrated in FIG. 3. In particular, it will be understood that ROADM architecture 300 may be dimensioned with fewer or more degrees for use in optical networks of different sizes, topographies, and complexity, such as optical network 101. It will be understood that additional input and output degrees may be used to extend the capacity of ROADM architecture 300. As shown in architecture 300, a route and collect bidirectional ROADM may include two route and collect ROADM blades 302-1 and 302-2.

In architecture 300, each ROADM blade 302 includes a route stage 310 and a collect stage 312. Route stage 310 may represent any route stage 210 described herein. Collect stage 312 may represent any collect stage 212 described herein. In the configuration of architecture 300, input degree 230-1 may arrive in a first direction along an optical network, while input degree 230 arrives in a second direction, opposite to the first direction, along another optical network. In some implementations, input degrees 230 may arrive along the same optical network in different directions. Correspondingly, third output degree 232-1 is transmitted along the optical network in the first direction, while third output degree 232-2 is transmitted along the other optical network in the second direction. In some implementations, third output degrees 232 are transmitted along the same optical network in different directions.

In architecture 300, route stage 310-1 of ROADM blade 302-1 may send first output degree 206-1 to collect stage 312-2 of ROADM blade 302-2. Correspondingly, route stage 310-2 may send first output degree 206-2 to collect stage 312-1 of ROADM blade 302-1. Also shown in architecture 300 are transmitter 102 and receiver 112, which are shown as single instances for descriptive clarity. It will be understood that a plurality of transmitters 102 and receivers 112 may be similarly connected in architecture 300. Specifically, a splitter 318 is used to route second input degree 209 from transmitter 102 to both collect stages 312, in order to add the wavelength to either transmission direction, as desired. Correspondingly, coupler 316 may be used to receive second output degree 207 from either route stage 310.

As disclosed herein, methods and systems for implementing a route and collect ROADM include a route stage incorporating a 1×2 wavelength selective element to split pass through wavelengths and dropped wavelengths from and input WDM signal. Additional optical functionality of the route and collect ROADM may be implemented using passive optical elements, such as a collect stage comprising an optical coupler to combine add wavelengths with the pass through wavelengths.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A reconfigurable optical add/drop multiplexer (ROADM), comprising:
a route stage enabled to receive an input degree and enabled to output a first output degree and a second output degree, wherein the route stage includes a wavelength selective element to route wavelengths in the input degree to at least one of the first output degree and the second output degree; and
a collect stage enabled to receive the first output degree from the route stage and a second input degree and enabled to output a third output degree, wherein the collect stage includes an optical coupler that combines the first output degree and the second input degree to generate the third output degree.

2. The ROADM of claim 1, wherein the wavelength selective element further comprises a 1×2 wavelength selective switch (WSS).

3. The ROADM of claim 1, wherein the wavelength selective element further comprises:
an optical splitter receiving the input degree and having a first output and second output;
a first waveblocker array receiving the first output and outputting the first output degree; and
a second waveblocker array receiving the second output and outputting the second output degree,
wherein the first waveblocker array and the second waveblocker array are respectively enabled to block individual wavelengths received as input.

4. The ROADM of claim 1, wherein the second output degree is a drop port for wavelengths in the input degree, and wherein the wavelength selective element routes each wavelength in the input degree to one of the first output degree and the second output degree.

5. The ROADM of claim 1, wherein the route stage further comprises:
an optical drop splitter to split the second output degree into a plurality of degrees.

6. The ROADM of claim 1, wherein the route stage further comprises:
an arrayed waveguide grating to split wavelengths in the second output degree into individual wavelength channels.

7. The ROADM of claim 1, wherein the collect stage further comprises:
an optical add coupler to combine add degrees for the second input degree.

8. The ROADM of claim 7, wherein the add degrees are individual wavelengths for the second input degree, and wherein the collect stage further comprises:
a plurality of variable optical attenuators (VOA) corresponding to the individual wavelengths and enabled to respectively attenuate each of the individual wavelengths.

9. The ROADM of claim 7, wherein the collect stage further comprises:
a third waveblocker array enabled to block wavelengths from the optical add coupler.

10. The ROADM of claim 1, wherein the collect stage further comprises:
an arrayed waveguide grating to combine wavelengths for the second input degree.

11. The ROADM of claim 1, wherein the route stage further comprises:
a first multicast switch enabled to receive the second output degree and another output degree from another route stage; and wherein the collect stage further comprises:
a second multicast switch enabled to output the second input degree and another input degree to another collect stage.

12. An optical network comprising:
a reconfigurable optical add/drop multiplexer (ROADM), further comprising:
a route stage enabled to receive an input degree and enabled to output a first output degree and a second output degree, wherein the route stage includes a wavelength selective element to route wavelengths in the input degree to at least one of the first output degree and the second output degree; and
a collect stage enabled to receive the first output degree from the route stage and a second input degree and enabled to output a third output degree, wherein the collect stage includes an optical coupler that combines the first output degree and the second input degree to generate the third output degree.

13. The optical network of claim 12, wherein the wavelength selective element further comprises a 1×2 wavelength selective switch (WSS).

14. The optical network of claim 12, wherein the wavelength selective element further comprises:
an optical splitter receiving the input degree and having a first output and second output;
a first waveblocker array receiving the first output and outputting the first output degree; and
a second waveblocker array receiving the second output and outputting the second output degree,
wherein the first waveblocker array and the second waveblocker array are respectively enabled to block individual wavelengths received as input.

15. The optical network of claim 12, wherein the second output degree is a drop port for wavelengths in the input degree, and wherein the wavelength selective element routes each wavelength in the input degree to one of the first output degree and the second output degree.

16. The optical network of claim 12, wherein the route stage further comprises:
an optical drop splitter to split the second output degree into a plurality of degrees.

17. The optical network of claim 12, wherein the route stage further comprises:
an arrayed waveguide grating to split wavelengths in the second output degree into individual wavelength channels.

18. The optical network of claim 12, wherein the collect stage further comprises:
an optical add coupler to combine add degrees for the second input degree.

19. The optical network of claim 18, wherein the add degrees are individual wavelengths for the second input degree, and wherein the collect stage further comprises:
a plurality of variable optical attenuators (VOA) corresponding to the individual wavelengths and enabled to respectively attenuate each of the individual wavelengths.

20. The optical network of claim 18, wherein the collect stage further comprises:
a third waveblocker array enabled to block wavelengths from the optical add coupler.

21. The optical network of claim 12, wherein the collect stage further comprises:
an arrayed waveguide grating to combine wavelengths for the second input degree.

22. The optical network of claim 12, wherein the route stage further comprises:
a first multicast switch enabled to receive the second output degree and another output degree from another route stage; and wherein the collect stage further comprises:
a second multicast switch enabled to output the second input degree and another input degree to another collect stage.
